(19) United States
(12) Patent Application Publication
(10) Pub. No.: US 2005/0201531 A1
(43) Pub. Date: Sep. 15, 2005

(54) System and method for selection of on-hold media content

(75) Inventors: Ricardo E. Kanter, Port Orchard, WA (US); Karrie L. Kanter, Port Orchard, WA (US); Gerald E. Marshall, Kingston, WA (US)

Correspondence Address: Ricardo E. Kanter, 4419 Beach Drive E., Port Orchard, WA, 98366, US

(73) Assignee: CircleLight LLC, Port Orchard, WA (US)

(21) Appl. No.: 11/056,814

(22) Filed: Feb. 10, 2005

Related U.S. Application Data
(60) Provisional application No. 60/543,317, filed on Feb. 10, 2004.

(51) Int. Cl. H04M 1/64; H04M 11/00

(52) U.S. Cl. 379/88.13; 379/88.16

(57) ABSTRACT

A system and method for selecting media content provided to a caller routed through a telephone switching system are provided. A telephone switching system interface is configured to exchange information with a telephone switching system and/or telephone lines feeding into the telephone switching system. A control unit is operably coupled with the telephone lines. The system includes an available media generator configured to convey to the telephone switching system interface a list of media selections available to a caller on hold. The system also includes a media choice selector configured to receive a media choice made by the caller on hold and couple the selected media source to the telephone line where the caller is on hold. The system and method are configurable to allow callers to select on-hold audio content without modifications to the telephone switching system by connecting with phone lines leading to the telephone switching system.

### RELATED APPLICATION

This application is based on a prior copending provisional application Ser. No. 60/543,317, filed on Feb. 10, 2004, the benefit of the filing date of which is hereby claimed under 35 U.S.C. § 119(e).

### FIELD OF THE INVENTION

This invention relates generally to telephone call receiving and switching and, more specifically, to on-hold media content for incoming callers.

### BACKGROUND OF THE INVENTION

Technology has both enabled and driven many changes in contemporary society. To name just one example, years ago merchants, service providers, and most other businesses tended to be small local companies. In this environment, business transactions frequently were conducted in person, on a face-to-face basis. However, the invention and the widespread proliferation of the telephone have significantly changed how business is done today. Items can be purchased, service calls can be arranged, and many other transactions can be consummated over the telephone. As a result of how the telephone has revolutionized the business world, as well as to take advantage of economies of scale, many smaller independent businesses have merged with or have been displaced by larger, centralized businesses. Although such larger businesses frequently have local agencies to deliver goods and services where desired, telephone calls that initiate the transactions may pass through one or more centralized call centers.

It is widely understood that such centralization naturally results in a potential bottleneck. Just as a flow of liquid may be slowed or stalled at a literal bottleneck where a relatively large body of liquid attempts to flow through a relatively narrow opening, a rush of numerous telephone calls simultaneously arriving at one large call center may be slowed or stalled. At one time, when a number of incoming telephone calls exceeded a number of lines at the call center, callers received a busy signal. To avoid losing potential customers upon encountering a busy signal, technology evolved to allow businesses to employ one or more receptionists to greet callers and place them “on hold” to await an opportunity to speak with representatives who could assist them.

Over time, an increasing number of businesses created “call centers” to centralize the handling of the countless calls being received, thereby resulting in a higher number of callers being placed on hold. To economize over the cost of human operators, automatic telephone answering and switching systems were devised to greet callers and inform them their calls had reached the call center. The telephone switching system would receive the calls and route the calls to an agent, or the system would automatically place the callers on hold and route their calls as agents became available. Such telephone switching systems are commonly termed private branch exchanges (PBXs) or “switches.”

With the passage of time, additional innovations were devised. The proliferation of the touch-tone phone allowed businesses to present callers with a menu of choices to identify why they were calling. Such systems allow a caller to self-direct his or her call to an appropriate agent when an appropriate agent became available to handle the previously-identified requests.

In addition to improvements to economize call center operation, more innovations were developed to make callers' on-hold experiences less unpleasant. For example, instead of only hearing “dead air” while on hold, which often left callers wondering if they had been disconnected, pre-selected audio was played for the callers. Such audio originally included prerecorded music. Eventually, some on-hold audio was replaced or augmented with advertisements for the business's goods or services. Also, prerecorded music was replaced with a radio station broadcast being routed to the caller. Further innovations monitored how many calls were being processed relative to the number of available agents, and an average call length to inform callers how long they might have to wait for an agent.

With all these improvements, however, the sometimes lengthy and, unfortunately, sometimes seemingly interminable waiting remained. Even though callers might be provided with some audio content to help break the monotony of their waits and the callers might be warned how long they might have to wait, callers still often are stranded for potentially lengthy periods. During these potentially lengthy waits, all the callers have to divert them from their mounting frustration is the on-hold audio provided by the business. Unfortunately, if the audio is irritating or unpleasant to the caller, the caller may terminate the call, and may never call back. The caller might choose not to pursue the transaction, or might choose another provider. Whichever the caller might choose, the caller's choice not to wait results in a lost opportunity for the business.

Thus, there currently is an unmet need in the art for a call receiving or switching system able to make the time callers spend on hold more enjoyable or, at least, more tolerable, in order to maintain good customer relations and avoid losing business.

### SUMMARY OF THE INVENTION

Embodiments of the present invention enhance relationships with callers who contact users of the invention by allowing the callers to choose content offered to them while waiting on hold. As opposed to conventional systems where callers are presented with a pre-selected choice of content, whether music, information, advertising, or other content, embodiments of the present inventions allow callers to select alternative content while waiting. Embodiments of the present invention evince respect and concern for callers' time by giving the callers a choice of content. Embodiments of the present invention also reduce callers' potential frustration in having to wait on hold by providing content that may help them more enjoyably to pass the time.

More particularly, embodiments of the present invention provide a system and method allowing a caller to choose content to be received from one or more audio sources and relayed to the caller while the caller is on hold. A telephone switching system interface is configured to exchange information with callers by tapping into telephone lines feeding into the telephone switching system.

In one embodiment of the present invention, a music on-hold tone is generated and supplied to an on-hold audio input on the telephone switching system. Because the telephone lines are monitored outside the telephone switching system, when it is detected that the music on-hold tone has been applied to a telephone line, indicating a caller is on hold, the system engages the telephone line on which the caller is on hold. The caller is provided with audio content options from which the caller can select by, for example, pressing a key on a telephone keypad. The system then engages audio content stored in a storage device within the system, or engages an external media source. The content from the on-board storage device or external media source is coupled with the telephone line where it can be heard by a caller.

In accordance with further aspects of the present invention, the music on-hold tone suitably is beyond the range of human hearing so that it will not be detected by a caller. Callers can make a different on-hold audio selection by choosing another option.

### BRIEF DESCRIPTION OF THE DRAWINGS

The preferred and alternative embodiments of the present invention are described in detail below with reference to the following drawings.

FIG. 1 is a block diagram of a telephone switching system receiving a call and using an embodiment of the present invention;

FIG. 2A is a block diagram of an audio controller according to an embodiment of the present invention;

FIG. 2B is a block diagram of an audio controller according to another embodiment of the present invention;

FIG. 3 is a flow diagram illustrating the logical steps for providing selectable on-hold audio according to an embodiment of the present invention;

FIG. 4 is a functional block diagram of an audio controller coupled with a conventional telephone switching system that provides for caller-selectable on-hold audio content without modifications to the telephone switching system;

FIG. 5 is a functional block diagram of a control system employed in the audio controller according to an embodiment of the present invention;

FIG. 6 is a functional block diagram of an audio system employed in the audio controller according to an embodiment of the present invention; and

FIG. 7 is a flow diagram illustrating the logical steps for providing caller-selectable on-hold audio using the system depicted in FIGS. 4-6.

### DETAILED DESCRIPTION OF THE INVENTION

By way of overview, embodiments of the present invention provide a system and method for allowing a caller to choose content to be received from a media source and relayed to the caller while the caller is on hold. A telephone switching system interface is configured to exchange information with a telephone switching system. A control unit is operably coupled with the telephone switch interface. The control unit includes an available media selection generator configured to convey to the telephone switching system interface a list of media selections available to a caller on hold. The control unit also includes a media choice selector configured to receive a media choice made by the caller on hold and generate a media selection signal indicative of the media choice made by the caller. A media source interface is configured to convey the media selection signal to a media source such that content associated with the media choice made by the caller generated by the media source is conveyed to the caller on hold.

Provision of Selectable Audio via a Device External to the Telephone Switching System

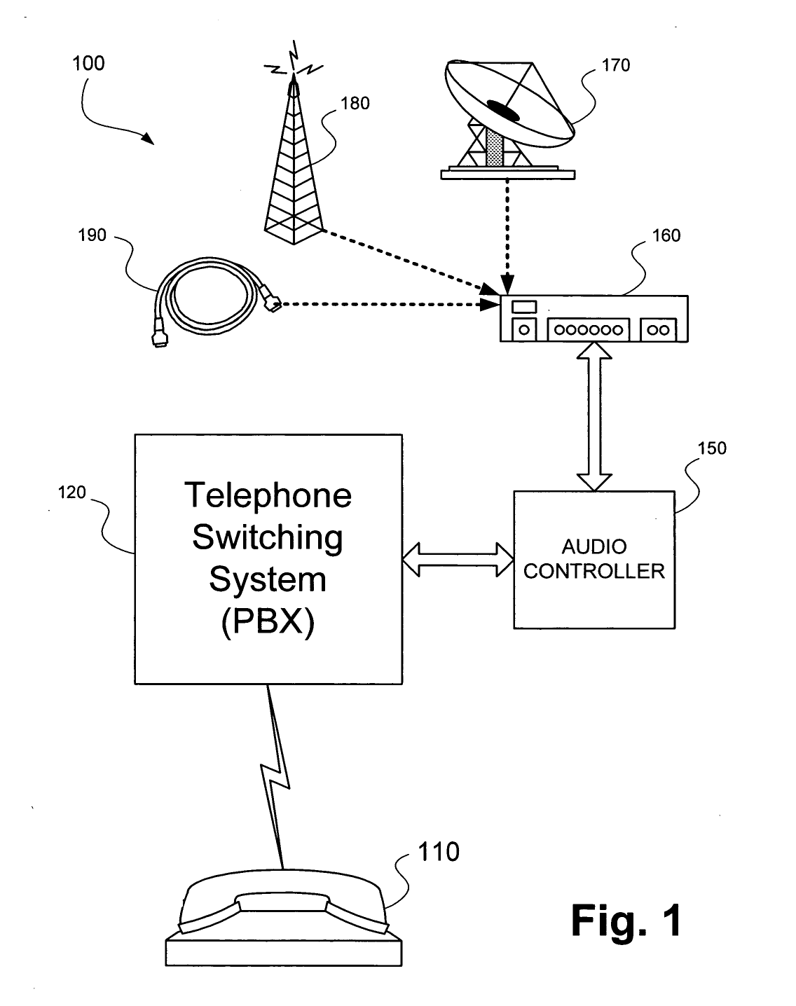

FIG. 1 shows a telephone switching system 100 using an embodiment of the present invention receiving a call. A caller (not shown) uses a telephone 110 to place a call to a user of the embodiment of the present invention. The call is received by a telephone switching system 120 such as a private branch exchange (PBX) or similar system. Telephone switching system 120 is operably coupled with an audio controller 150 that supports functions in accordance with embodiments of the present invention. The described embodiment concerns an audio-only telephone system wherein the media selections provided for callers are audio only. It will be appreciated that, using a multi-media telephone or other calling system, multimedia audio including video, audio, and/or other content could be provided to the callers.

Audio controller 150 interfaces with telephone switching system 120 to interact with calls and callers reaching telephone switching system 120. Audio controller 150 also interfaces with one or more audio sources 160. The audio source 160 suitably includes one of a satellite receiver coupled with a satellite antenna 170, a broadcast receiver coupled with a broadcast antenna 180, or a cable receiver coupled with a cable input 190. The audio source 160 also suitably includes a prerecorded audio player, such as a tape player, a disc player, or a media file player (not shown).

In addition, audio source 160 suitably includes a media insert preferably configured to be included within audio controller 150, such that prerecorded audio content, tailorable by the operator of telephone switching system 120, can be provided to callers without employing an external audio source to generate the audio content. For example, as is known in the art, audio can be stored on a memory device, such as a Secure Digital (SD) card, from which audio can be generated. The SD card may accommodate one or more WAV, AA4, MP3, or similarly formatted files compressed using a compression algorithm that is decoded using known means. Audio also can be stored in recordable audio chips including built-in audio generation capabilities, such as Winbond ChipCorders™. It will be appreciated that, if the audio content is stored in such a digital medium, the content is immediately available for playback by audio controller 150.

Audio controller 150, described in further detail below, receives selection input from telephone switching system 120, generates a suitable audio selection signal which causes the desired audio source 160 to be selected for presentation to a caller. Audio source 160 retrieves and generates the desired audio content. The audio content produced is routed through telephone switching system 120 where it is directed to telephone 110 and, thus, to the caller.

In operation, a caller using telephone 110 places a call to contact the entity using telephone switching system 120. If the call is placed on hold at telephone switching system 120, by either a human operator or an automatic answering system, audio controller 150 engages the call to offer a list of choices of available audio content that can be delivered to the caller while waiting on hold. The available choices of audio selections might be read to the caller by a prerecorded voice or by a computer-synthesized voice. For example, the caller might be given the following message:

“While you are waiting, you can choose to listen to one of the following types of programs by pressing the appropriate key on your touch-tone phone. For classical music, press 1. For contemporary popular music, press 2. For adult contemporary music, press 3. For country music, press 4. For jazz, press 5. For news, press 6. Please continue to hold for person or department you are trying to reach.”

Upon making his or her selection, audio controller 150 decodes the touch-tone-generated tones resulting from the caller's selection. Audio controller 150 then generates an audio selection signal that will cause the audio source to generate the caller's choice of audio content. For example, if the caller selects classical music by pressing 1 and audio source 160 is a satellite radio receiver coupled to a satellite antenna, such as an XM® Satellite Radio System, audio controller 150 would generate a signal causing selection of the satellite radio receiver tuned to a classical music station. The audio selection signal suitably is in the form of an electronic digital signal that causes the desired audio source 160 to be selected via a wired connection and presented to the caller. Similarly, if audio source 160 is a broadcast media or cable source, the audio controller 150 would generate a suitable signal configured to select audio source 160 to retrieve the caller's desired audio content. Alternatively, if audio source 160 is a prerecorded music source, desired discs, or files suitably are retrieved to be played for the caller. Further alternatively, if audio source 160 is a media insert included within audio controller 150, data stored within the media insert representing its audio content is decoded as necessary and provided to the user. An audio output of audio source 160 can be coupled to telephone lines and presented to the caller.

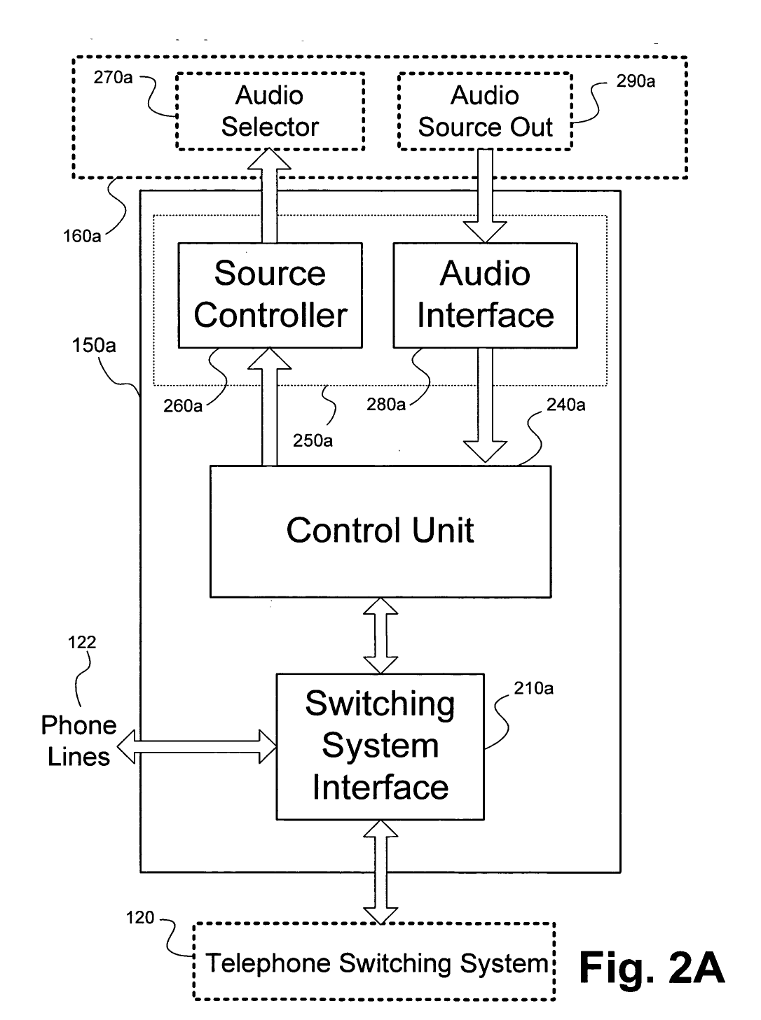

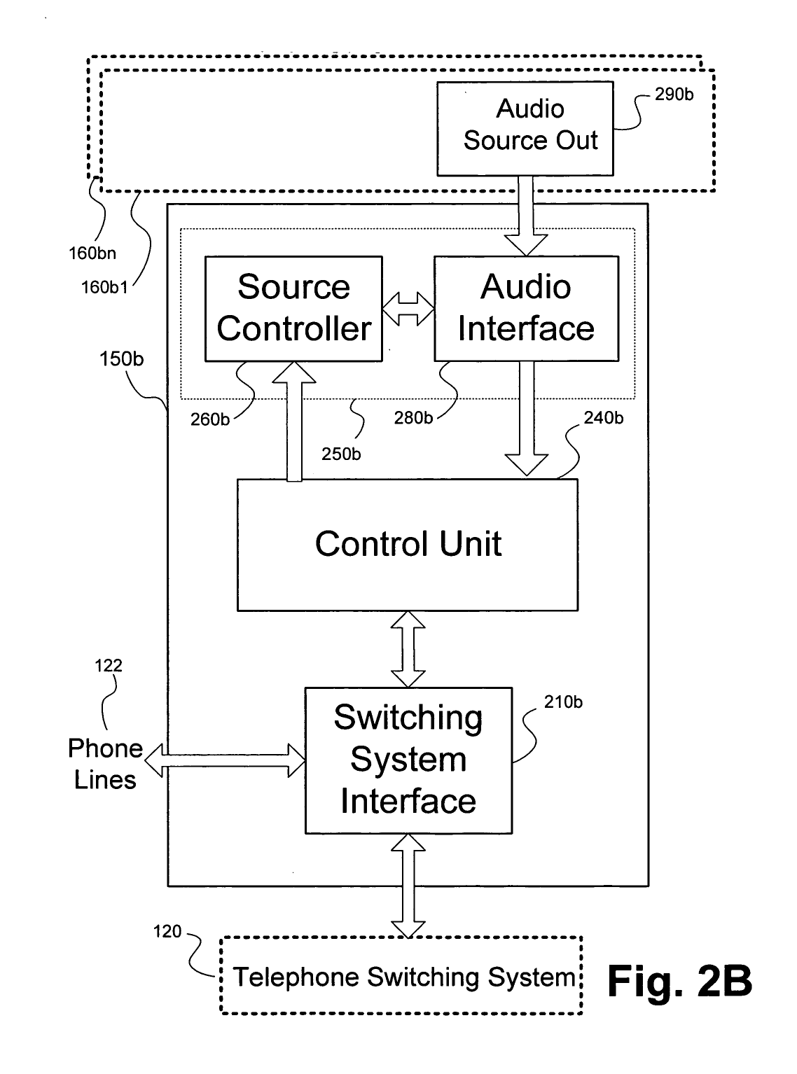

FIG. 2A is a block diagram of an embodiment of audio controller 150 of FIG. 1. Audio controller 150a is operable coupled to telephone switching system 120 via a switching system interface 210a configured to operate with telephone switching system 120. Switching system interface 210a is suitably configured to physically interconnect with telephone switching system 120 and operationally exchange data with telephone switching system 120 and/or phone lines 122.

In one preferred embodiment of the present invention, and as previously described, the list of choices of available audio content is generated by a control unit 240a coupled with the switching system interface 210a. Control unit 240a includes suitable control logic, program storage, data storage, and audio coders and decoders to direct operations of audio controller 150a. The control logic of control unit 240a may include a microprocessor. The program storage can be stored in read-only memory, non-volatile rewriteable memory, or another type of suitable memory. Memory space needed for data storage suitably is provided by random-access memory for storing caller inputs. Audio coders and decoders suitably include components to receive and sample audio inputs and memory in which to store and from which to replay audio messages.

The list of choices generated by control unit 240 is routed through switching system interface 210a and audibly presented to the caller. The caller makes a choice from the list by pressing a key on the caller's telephone keypad which generates a touch-tone audio signal received by switching system interface 210a. Control unit 240a receives the audible touch-tone selection from switching system interface 210a and decodes the touch-tone to determine which choice from the list of available audio content was made by the caller.

Once the caller's selection is decoded by the control unit 240, the control unit 240 directs an audio source interface 250a to retrieve the caller's chosen audio selection and communicate the audio selection to the caller. More specifically, the audio source interface 250a includes a source controller 260a and an audio interface 280a. Control unit 240a engages receiver controller 260a to direct audio source 160a to provide the caller's audio selection. Source controller 260a suitably includes an interface configured to engage an audio selector 270a pf one or more audio sources 160a that may be used. For one non-limiting example, if audio source 160a has an audio selector 270a supporting a wired interface, source controller 260 is configured to generate an appropriate wired audio selection signal to direct audio selector 270 to retrieve the audio selection of the caller's choice. Alternatively, for another non-limiting example, if audio source 160a has an audio selector 270a accepting a wireless signal, such as an infrared or similar remote control signal, source controller 260a is configured to generate an appropriate wireless audio selection signal to direct audio selector 270a to retrieve the audio selection of the caller's choice. Control unit 240 and the source controller 260a are configured to interact with audio selector 270a of audio source 160a, and are configured to map the audio selections presented to the caller to corresponding audio selections audio source 160a is operable to provide.

Once source controller 260a directs audio selector 270 of audio source 160a to tune to, switch to, or otherwise retrieve the audio selection chosen by the caller, audio interface 280a of the audio source interface 250a receives output from an audio source output or audio source out 290a of audio source 160a. Audio interface 280a may receive audio content using a wired or wireless connection with audio source out 290a. The content provided by audio source out 290a may be analog or digital. Audio content generated by audio source out 290a and received by audio interface 280a, if compatible with the telephone switching system 120, may be coupled through control unit 240a directly through the switching system interface 210 to telephone switching system 120. Alternatively, depending on the interfaces existing on switching system 120 and the compatibility of content generated by audio source out 290a, the audio content provided by audio source out 290a may be coupled directly from the audio interface 280a to telephone switching system 120, coupled directly from the audio source out 290a to telephone switching system 120, or coupled with the telephone switching in another suitable way that directs the content provided by audio source out 290a to the caller. If the content generated by audio source out 290a is not compatible with telephone switching system 120, audio interface 280a, independently or suitably in conjunction with the control unit 240a, converts the content generated by audio source out 290a to a signal usable with telephone switching system 120. Audio interface 290a and/or control unit 240 suitably convert the content generated or provided by audio source out 290a appropriate from digital to analog or from analog to digital, or the content is otherwise processed to make it usable with telephone switching system 120. Alternatively, audio content provided by audio source out 209a may be coupled directly from audio source out 290a to a phone line 122 where the caller is on hold.

Audio controller 150a suitably includes a separate, dedicated hardware device coupled with telephone switching system 120, audio source 160a, and phone lines 122. Audio controller 150 suitably includes a separate, standalone hardware device, or a module or card that can be installed in telephone switching system 120. Alternatively, if telephone switching system 120 includes a programmable computer system, instructions providing for the selection of audio content can be programmed into telephone switching system 120, thereby configuring telephone switching system with capabilities of audio controller 150.

FIG. 2B is a block diagram of another embodiment of the audio controller 150 of FIG. 1. The audio controller 150b is operable coupled to the telephone switching system 120 via a switching system interface 210b configured to operate with the telephone switching system 120. The switching system interface 210b is suitably configured to physically interconnect with the telephone switching system 120 and operationally exchange data with the telephone switching system 120 and/or the telephone lines (not shown). As in the embodiment shown in FIG. 2A, audio controller 150b also includes a control unit 240b, a source controller 260b, and an audio interface 280b.

As distinct from the embodiment shown in FIG. 2A, audio interface 280b interconnects with one audio source out 290b of a single audio source 160b1. Other audio interfaces like audio interface 280b (not shown), receive an audio source out from additional audio sources through 160bn to provide n audio sources. In contrast to the embodiment shown in FIG. 2A, audio controller 150b provides multiple sources of audio content not by switching audio sources 160b1 or 160bn to generate another source. Instead, source controller 260b selects between a plurality of audio interfaces like audio interface 280b to select from among audio content generated by audio sources 160b1 through 160bn.

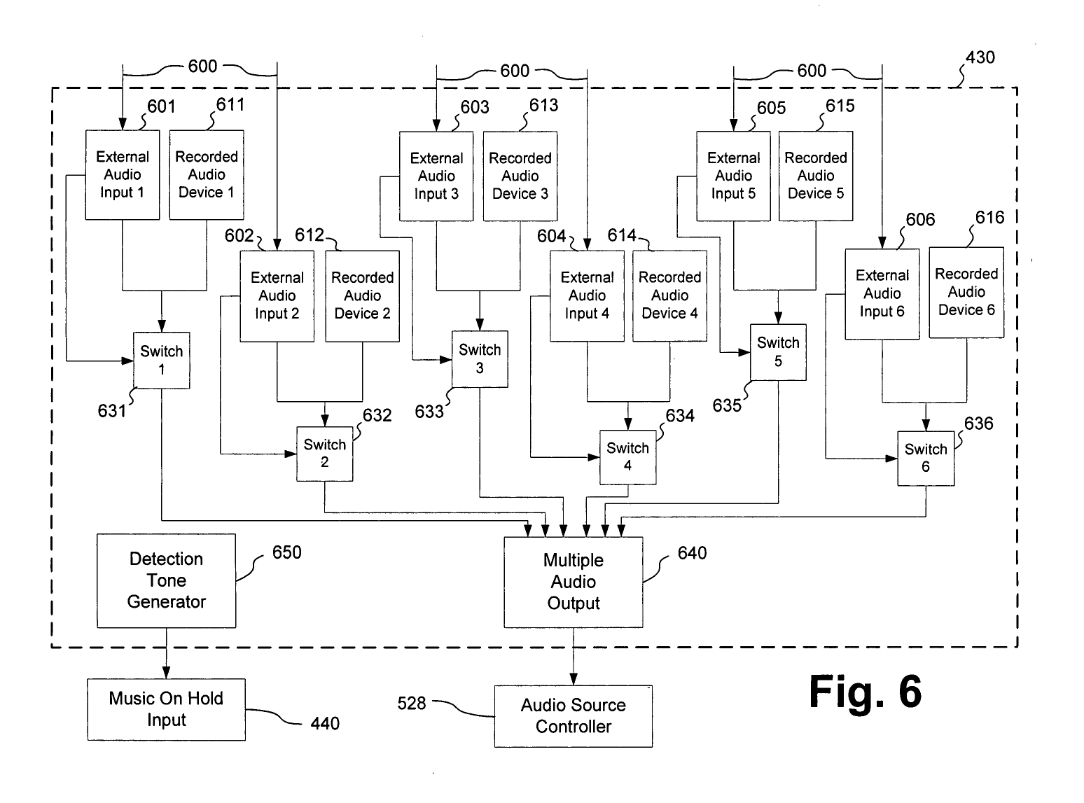

In addition, although not shown in either FIG. 2A or FIG. 2B, audio controllers 150a and 150b may include internal audio sources selectable by control unit 240b and source controller 260b. Embodiments of the present invention providing for incorporated audio sources are described below in connection with FIG. 6.

Method for Allowing Callers to Select On-Hold Audio

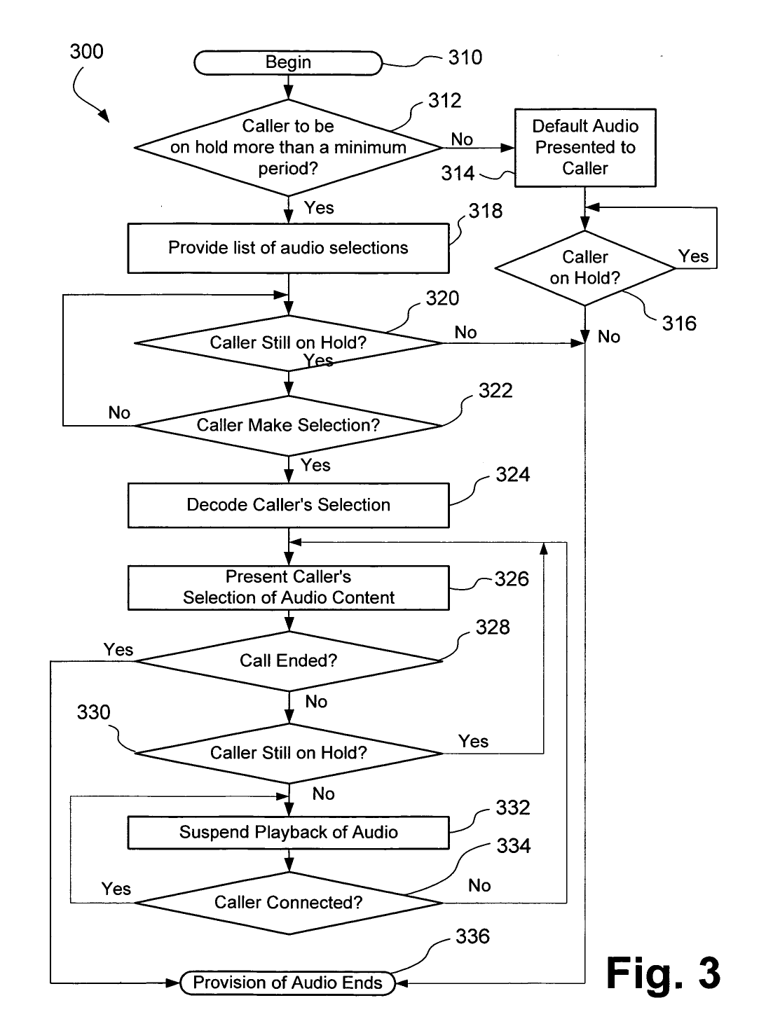

FIG. 3 is a flowchart of a preferred embodiment of a flow diagram 300 according to an embodiment of the present invention. Flow diagram, 300 begins at step 310. At a decision step 312, it is determined if a caller will be on hold for more than an established, minimum period. Telephone switching systems currently are capable of assessing on-hold time and passing the anticipated on-hold time to the caller. The anticipated on-hold time also is used by embodiments of the present invention. It may not be desirable to present a caller with a list of available audio choices if the caller is expected to be on hold for only a short period. For example, explaining to the caller that he or she can choose audio selections and presenting those selections would consume several seconds. Thus, if the caller is expected to be on hold for a minute or less, or some other predetermined interval, it may not be desirable to offer the caller a list of audio selections when the caller would be presented with his or her selected audio content for only a few seconds before being connected with an agent.

Thus, if it is determined at decision step 312 that the caller will not be on hold for more than an established minimum period of time, flow diagram 300 proceeds to step 314 where the caller is provided with a default audio selection. The default audio selection may include a message from the proprietor of the business operating the telephone switching system and/or a default music selection, as will be further described below. Once the default audio selection is presented to the user at step 314, at decision step 316, it is determined if the caller continues to be on hold. If so, flow diagram 300 loops to decision step 316 to determine if the caller continues to remain on hold. On the other hand, if it is determined at decision step 316 that the caller is no longer on hold, flow diagram 300 proceeds to step 330 where provision of audio ends, either because the caller is connected to the party the caller intended to reach or has ended the call.

On the other hand, if it is determined at decision step 312 that the caller will be on hold for more than the established minimum period, then at step 318 the caller is presented with a list of audio selections as previously described above in connection with FIG. 1. Once the caller is provided with audio selection choices at step 318, at decision step 320 it is determined if the caller is still on hold. If not, either because the caller has terminated the call or has been routed to the person or department he or she was trying to reach, the flow diagram 300 proceeds to step 330 where provision of audio ends.

However, if at decision step 320 it is determined that the caller is still on hold, at decision step 322 it is determined if the caller has made a selection from the choices provided at step 318. If not, the flow diagram returns to decision step where it is determined if the caller is still on hold and, if so, it again is determined at decision step 322 if the caller has made a selection. The flow diagram 300 continues to loop through the decision steps 320 and 322 until the caller makes a selection or the caller is no longer on hold. In alternative embodiments of the present invention (not shown), if the caller has not made a selection after a predetermined interval of time or after the list of selections has been repeated a predetermined number of times, a default audio track may be presented.

At decision step 322, if it is determined that the caller has made an audio selection, at a step 324 the caller's selection is decoded from the touch-tones generated by the caller pressing keys on his or her telephone keypad corresponding with his or her audio selection. In one embodiment of the present invention, the caller can change his or her selection at any time while on hold by making a new selection. It will be appreciated that the caller also could make a selection in another, such as by speaking a number corresponding with a particular choice if the system controlling the audio is equipped with voice decoding. Once the caller's selection is decoded at step 324, at step 326, the caller is presented with the caller's selected audio.

Once the caller is presented with the selected audio content at step 326, at decision step 328 it is determined if the call has ended. If so, flow diagram ends at step 336. On the other hand, if it is determined at decision step 328 that the call has not ended, at decision step 330, it is determined if the caller is still on hold. If so, flow diagram 300 loops to step 326 to continue to provide the caller with the selected audio content. On the other hand, if it is determined at decision step 330 that the caller is not still on hold, at step 332, playback of the selected audio is suspended. At decision step 334, it is determined if the caller is still connected to the caller's desired party. If so, flow diagram 300 loops to step 332, where suspension of the audio content continues. On the other hand, if it is determined at decision step 334 that the caller is not still connected to an intended party, flow diagram 300 loops to step 326 to resume presentation of the selected audio until the call ends or the caller reaches an intended party.

Many alternative forms of the system, computer-readable medium, and system may be created in keeping with embodiments of the present invention. For example, the caller may be informed upon making his or her selection that he or she can choose to return to the menu to make a different audio selection by pressing a particular key or series of keys on the telephone keypad. When the identified key or series of keys is pressed, the flow diagram 300 (FIG. 3) may reinitiate at the step 318 to present the caller with a choice of audio selections and allow the caller to make another choice. Further alternatively, after the caller has been on hold for a pre-established period, the caller automatically may be reminded of other choices available, and re-offered the list of choices to make another audio selection, or be offered what key to press on the telephone keypad to hear the list of available selections. If the selections are suitably short, after one selection ends, the caller may be prompted with the list of choices. Many alternatives may be adopted in keeping with embodiments of the present invention.

System Providing Selectable On-Hold Audio With a Standard Telephone Switching System

In one embodiment of the present invention, provision of selected on-hold audio is provided to callers via a telephone switching system having a standard, conventional on-hold music input without making any modifications to the telephone switching system. Conventional telephone switching systems often include a single audio import configured to receive an audio line that can be connected to an audio receiver, a recorded music player, or some other conventional audio source. The telephone switching system is thus configured to connect the caller's telephone line to the audio line-in when the caller is placed on hold. As a result, each caller hears the same audio content presented to the single audio line in on the telephone switching system while the caller is on hold.

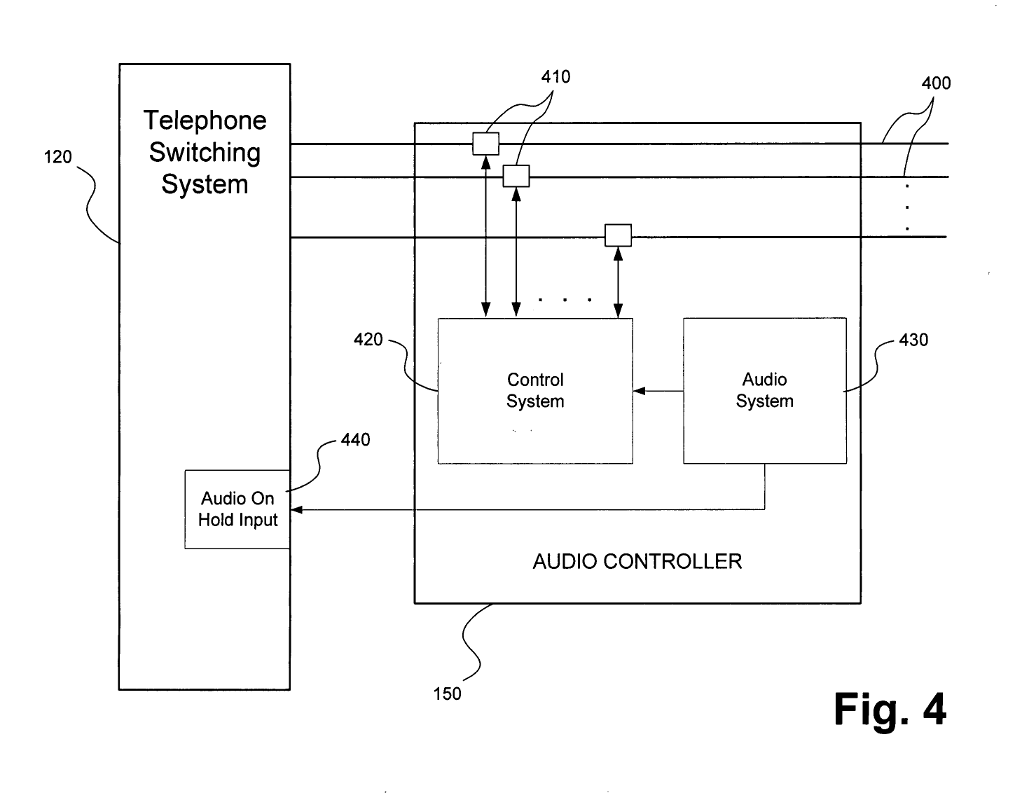

As shown in FIG. 4, and audio controller 150 according to an embodiment of the present invention takes advantage of the audio on-hold input 440 of the telephone switching system 120 to provide selectable on-hold audio content to callers, as will be further described below. As shown in FIG. 4, a plurality of telephone lines 400 is connected to telephone switching system 120. Unlike a typical telephone switching system installation, however, before telephone lines 400 are coupled with telephone switching system 120, telephone lines 400 passed through audio controller 150. In one embodiment of the invention, one or more line-in jacks, such as RJ-11 or RJ-45 type jacks, may be provided on audio controller 150, while also providing an equivalent, corresponding set of telephone line-out jacks allowing the telephone lines 400 to be connected with telephone switching system 120. Audio controller may be adapted to receive other forms of connectors, or to tap directly into conductors in a telephone cable.

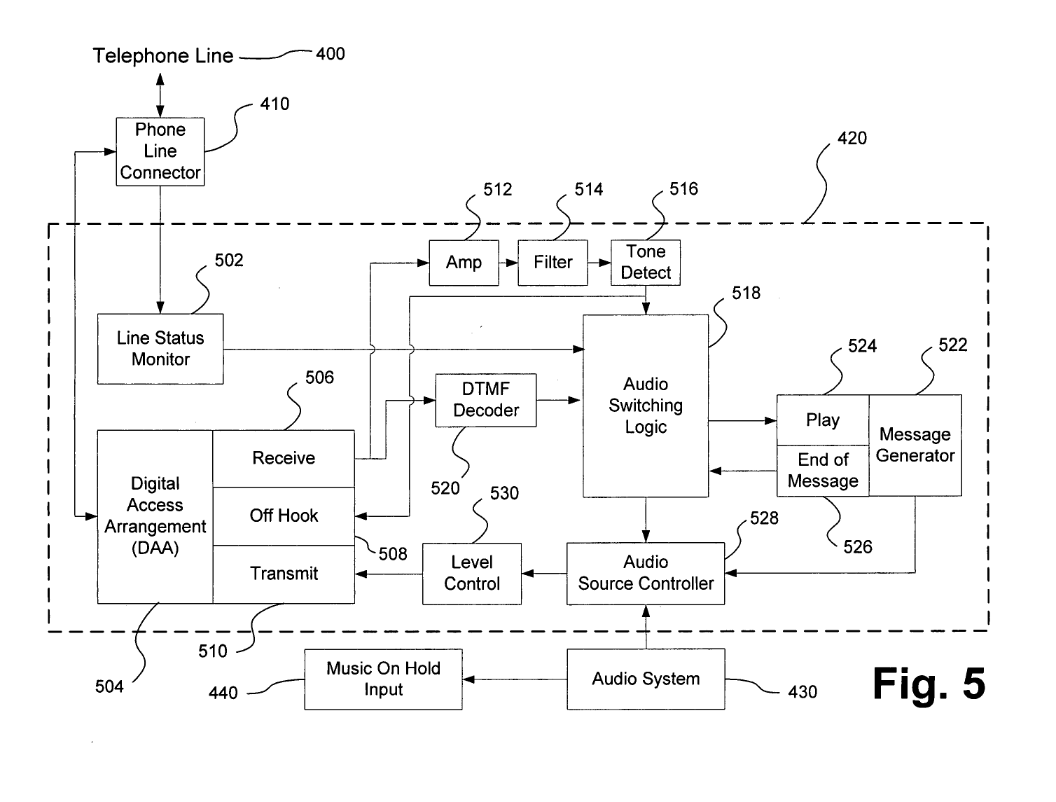

With an audio controller 150, telephone lines 400 are tapped by phone line connectors 410. As will be described further in connection with FIGS. 5 and 6, signals received over telephone lines via phone line connectors 410 are received by control system 420. Output generated both by control system 420 and received from audio system 430 are applied as output on telephone lines 400 via phone line connectors 410. Audio system 430 is also coupled directly with audio on-hold input 440 of telephone switching system 120. However, the audio content provided directly by audio system 430 to the telephone switching system 120 is not the on-hold content that will be presented to callers over telephone lines 400. Instead, as will be described further below, in one embodiment of the present invention the audio content provided by audio system 430 directly to audio on-hold input 440 of telephone switching system 120 is what enables callers to select audio content of choice while on hold.

More specifically, in addition to a plurality of choices of on-hold audio content offered to callers, audio system 430 also generates a music on-hold tone. Preferably, the music on-hold tone generated by the audio system 430 is outside the range of human hearing so that callers will not be aware of the signal. In one embodiment of the present invention, the music on-hold tone generated by audio system 430 is at a frequency of 30 kHz, well beyond the range of human hearing, at the high-frequency end, of 20 kHz. Alternatively, the music on-hold tone might be generated at a frequency below the lower limit of human hearing which, typically, is no lower than 20 Hz. A music on-hold tone within the range of human hearing also is usable, but may be less desirable because of the possibility of the music on-hold tone being detected by distracting to callers.

The music on-hold tone generated by audio system 430 and coupled to audio on-hold input 440 of telephone switching system 120 takes advantage of the normal, ordinary operation of telephone switching system 120 to activate audio controller 150. When a caller reaches telephone switching system 120 via telephone lines 400 is put on hold, telephone switching system 120 applies the audio content supplied at audio on-hold input 440 to any of the telephone lines 400 that are presently on hold. As previously described, using an embodiment of the present invention, once callers are put on hold, the music on-hold tone generated by audio system 430 is the audio content that is applied to telephone line 400. Via phone line connectors 410, control system 420 can thus to attack in which telephone lines 400 are presently on hold. Therefore, upon detecting telephone lines 400 that are both active and on hold, audio controller 150 then communicates with telephone lines 400 via phone line connectors 410 to provide callers with choices of on-hold audio content, receive a selection of audio content, and provide the selected on-hold audio content to callers via telephone lines 400.

Expressed another way, the music on-hold tone generated by audio system 430 within audio controller 150 feeds back into audio controller 150 a caller is put on hold. Upon detecting that feedback signal at a phone line connector 410, control system 420 uses phone line connectors to interact with callers of via telephone lines 400 independent of the operation of telephone switching system 120.

When a caller is taken off hold, telephone switching system 120 will disconnect the caller's telephone line 400 from the audio content supplied at audio on-hold input 440. As a result, the music on-hold tone will no longer be carried by the telephone line 400 carrying and now off hold caller. Via phone line connector 410, control system 420 test detects that the caller is no longer on hold and, thus, disconnects the caller's selection of on-hold audio content. If a caller is again placed on hold, telephone switching system 120 again causes the music on-hold tone received at the audio on-hold input 440 to be applied to telephone line 400 and, thus, reconnects the selected on-hold audio content provided by audio system 430 and controlled by control system 420 to the caller. Again, telephone switching system 120 need not include any special functionality to provide the selectable on-hold audio content for callers. Moreover, the provision of selectable on-hold audio content is entirely transparent to users directly connected to telephone switching system 120. Users of telephone switching system 120 merely place callers on hold and take them off hold as they had previously; audio controller 150 handles the rest.

Control System for Providing Selectable On-Hold Audio

FIG. 5 is a functional block diagram of control system 420 usable to detect when callers are on hold and allow callers to select on-hold audio. As previously described in connection with FIG. 4, control system 420 interacts with telephone line 400 via a phone line connector 410 that receives telephone lines and allows the telephone lines 400 to also be connected to telephone switching system 120 (FIG. 4) according to an embodiment of the present invention.

In one embodiment of the present invention, control system 420 as shown in FIG. 4, may include a plurality of separate control systems, one for each telephone line 400. Such a system allows callers each to select his or her own on-hold audio content, but can share a range of audio sources with a plurality of other, similar control systems. Thus, in accordance with an embodiment of the invention shown in FIG. 5, control system 420 detects such an individual telephone line control system. It will be appreciated in a plurality of such individual control systems could be housed and powered within a single housing that also includes audio sources and/or connections for external audio sources shareable by the individual control systems.

Phone line connector 410 allows control system 420 both receive information from telephone line 400 as well as communicate audio information over telephone line 400.

Line status monitor 502 monitors phone line connector 410 to determine if telephone line 400 carries an active telephone call. Systems and methods for detecting whether telephone line 400 carries an act to call are known by those skilled in the art. Line status monitor 502 communicates when the line is active to audio switching logic 518.

Phone line connector 410 also is coupled with a digital access arrangement (DAA) 504. Digital access arrangement 504, like those used in computers for modem devices and in other systems, is also understood by those ordinarily skilled in the art. Digital access arrangement 504 provides a receive the output 506 usable to receive communications over telephone line 400, and off the hook control 508 usable to keep a call active on telephone line 400, and they transmit input allowing for communications to be transmitted over telephone lines 400.

The receive output 506 of digital access arrangement 504 is supplied to an amplifier 512, filter 514, and toned detect device 516. Amplifier 512 amplifies the signal provided by receive output 506, while filter 514, in one embodiment of the present invention, is a high pass filter configured to mask frequencies other than those in which the music on-hold tone is generated. Thus, tone detect device 516 monitors the amplified and filtered signal generated by receive output 506. When a signal is detected by tone detect device 516 in the form of a voltage in the frequency range of the music on-hold tone, tone detect device 516 signals that a caller is on hold on the connected telephone line to audio switching logic of 518. Tone detect device 516 also signals to off hook 508 control of digital access arrangement 504 to couple digital access arrangement 504 to phone line connector 410. In an embodiment of the present invention, while control system 420 monitors telephone line 400, it does not actually interact with telephone line 400 until the music on-hold tone is detected by tone detect device 516.

Also, receive the output 506 is coupled to a dual tone multi-frequency (DTMF) decoder 520 which, as known to those skilled in the art, decodes the DTMF signals generated by touch-tone telephone keypads to determine which key has been pressed by the caller. As will be described further below, DTMF decoder 520 is used to elicit caller selections regarding on-hold audio content. Other embodiments of the invention may elicit caller input in other ways, such as by voice recognition, as well. Output of DTMF decoder 520 also is received by audio switching logic 518.

Audio switching logic 518, upon detecting via line status monitor 502 the line is active, and upon detecting via tone detect device 516 that the caller on telephone line 400 has been placed on hold, engages message generator 522. Message generator 522, in one embodiment of the present invention, includes a digitized prerecorded message listing audio choices available to the caller and which key on the caller's telephone keypad to press to select each. Message generator 522 also could be implemented using a speech to text generator to synthesize a scripted message, or some other technology capable of delivering the audio choice message to the caller. Message generator 522 includes a message play activator 524 that initiates of the message upon receiving a signal to start play from audio switching logic 518. Message generator 522 also includes an end of message detector 526 that determines when generation of the message is complete. End of message detector 526, communicates to audio switching logic 518 of the message has completed playback. In one embodiment of the present invention, audio switching logic, upon receiving a signal from end of message detector 526 the message has been completed, will signal message play activator 524 to cause message generator 522 to replay the message. Audio switching logic 518, thus, may direct message generator 522 to continue to play the audio selection message until the caller has entered a selection.

Audio switching logic 518 determines when a caller has entered an audio selection upon receiving the caller selection from DTMF decoder 520. Upon receiving a selection choice from DTMF decoder 520, audio switching logic 518 sends a signal to message play activator 524 to cease playback of the message, thus stopping message generator 522.

Output of message generator 522 is routed to an audio source controller 528. Audio switching logic 518 controls audio source control or 528, more specifically, causing audio source control or 528 to provide either the content generated by message generator 522 or one of a number of available audio selections provided by audio system 430 telephone line 400 via phone connector 410. More specifically, output of audio source control of 528 is passed to an automatic level control 530 which either raises or lowers the output level of whatever audio content audio switching logic 518 is directed audio source control or 528 to direct to the caller. Automatic level control 530 automatically controls the level of the audio content received from audio source controller 528 to a consistent, predetermined level so that the user not be overwhelmed upon selecting on-hold audio content that may provide a louder input signal to audio source controller 528 than, for example, is produced by message generator 522 or any of the other selections of on-hold audio content. The output of automatic level control 530 is provided to transmit input 510 of digital access arrangement 504, and then connected to telephone line 400 via phone line connector 410.

In sum, control system 420 detects both when telephone line 400 is active in when the caller on telephone line 400 has been placed on hold by detecting that telephone line 400 carries the music on-hold tone. Audio switching logic 518 causes an audio selection message to be presented to the caller and, when the caller makes a selection, DTMF decoder 520 communicates to audio switching logic 518 of the selection. Audio switching logic 518 controls whether the caller hears the message produced by message generator 522 or on-hold audio content produced by audio system 430 and selected by audio source controller 528.

Audio system 430, in one embodiment of the present invention, not only generates on-hold audio content that will be supplied to callers, but also generates the music on-hold tone supplied to the telephone switching system (not shown) via the music on-hold input 440 that initiates the on-hold audio content selection process. Audio system 430 is further described below in connection with FIG. 6.

Audio System for Facilitating Selectable On-Hold Audio

FIG. 6 is a functional block diagram of audio system 430 usable to produce audio content to facilitate provision of on-hold audio content. In particular, audio system 430 has two principal functions. First, as previously described, audio system 430 includes a detection tone generator 650. Detection tone generator 650 produces the music on-hold tone that is provided as input to music on-hold input 440 of the telephone switching system (not shown). In one embodiment of the present invention, detection tone generator is an oscillator that continually generates a 30 kHz tone. The 30 kHz music on-hold tone is not detectable by callers connected to the system, but as previously described, is detectable by control system 420 (FIG. 5) to initiate provision of audio content services.

Second, audio system 430 produces multiple audio output 640 that is supplied to audio source controller 528 of control system 420. In one embodiment of the present invention, where multiple single-line control systems 420 are used for each telephone line as previously described, audio system 430 provides a plurality of selectable audio content choices. Accordingly, even if multiple separate control systems 420 are used to service a plurality of phone lines, a single audio system is able to provide the selectable audio content to each of those control systems 420. Each of the available on-hold audio content choices is provided to each of the control systems 420 where they are selected by audio source controller 528. In one embodiment of the present invention, multiple audio output 640 includes a plurality of individual signal lines suitable for conveying all of the on-hold audio content selections to each of the audio source controller's 528.

Users of embodiment of the present invention may desire to provide callers with a range of choices that include informational, promotional, and entertainment selections. For example, if an embodiment of the present invention is used by a financial institution, the institution may desire to provide callers on hold with information about different financial products offered by the financial institution, or various financial tips that callers may find informative and, thus, provide added value as perceived by the caller. Conventionally, many callers on hold are presented with promotional information about the institution they are calling. However, that information is presented as part of an unchanging ongoing loop that is presented to all callers whether they want to hear that information or not. This promotional information often is pre-recorded onto a looping tape device that endlessly repeats the prerecorded message.

Using embodiments of the present convention, the financial institution would not be limited to endlessly playing the same message for callers are placed on hold, who may miss messages of interest or placed on hold and connected when the message of interest has mostly or completely played to its end. Instead, individual, updatable messages may be recorded and stored on digital memory devices insertable in audio system 430 as recorded audio devices 611-616. Digital media used to record messages may include secure Digital cards, memory sticks, and similar nonvolatile or flash memory devices using any one of a number of digital recording and/or compression techniques, and can be regenerated using corresponding playback and/or decompression techniques. Thus, in the audio system 430 used in the embodiment of the present invention shown in FIG. 6, six different prerecorded audio messages are insertable into audio system 430. The audio selection message generated by message generator 522 (FIG. 5) should be updated to reflect the available choices stored in recorded audio devices 611-616.

In addition to prerecorded audio messages, the institution using an embodiment of the present invention may wish to allow callers to listen to other audio content. For example, a number of different radio stations may be made available for callers to listen to while waiting, such as news, sports, or various music stations. Accordingly, audio system 430 includes a plurality of external audio inputs 601-606 configured to receive audio line inputs 600. External audio inputs 601-606 may include standard audio input jacks, such as 1/8 inch audio jacks used by a number of ubiquitous audio sources. Because a telephone is a mono folic audio device, external audio inputs 601-606 may include stereo-to-mono jacks.

In one embodiment of the present invention, outputs of both external audio inputs 601-606 and recorded audio devices 611-616 are connected to a switch 631-636, respectively. In one embodiment of the present invention the input jacks used by external audio inputs 601-606 automatically will switch the input from recorded audio device to the external audio input. As is understood in the art, self switching jacks are used even in common household devices, such that an external speaker is disconnected once an earphone or headphones are plugged in to appropriate jack. All the audio choices, as previously described, are routed to the multiple audio output which in turn is coupled with audio source controller 528 in control system or control systems 420.

Method of Detecting Callers On-Hold and Providing Selected On-Hold Audio Content

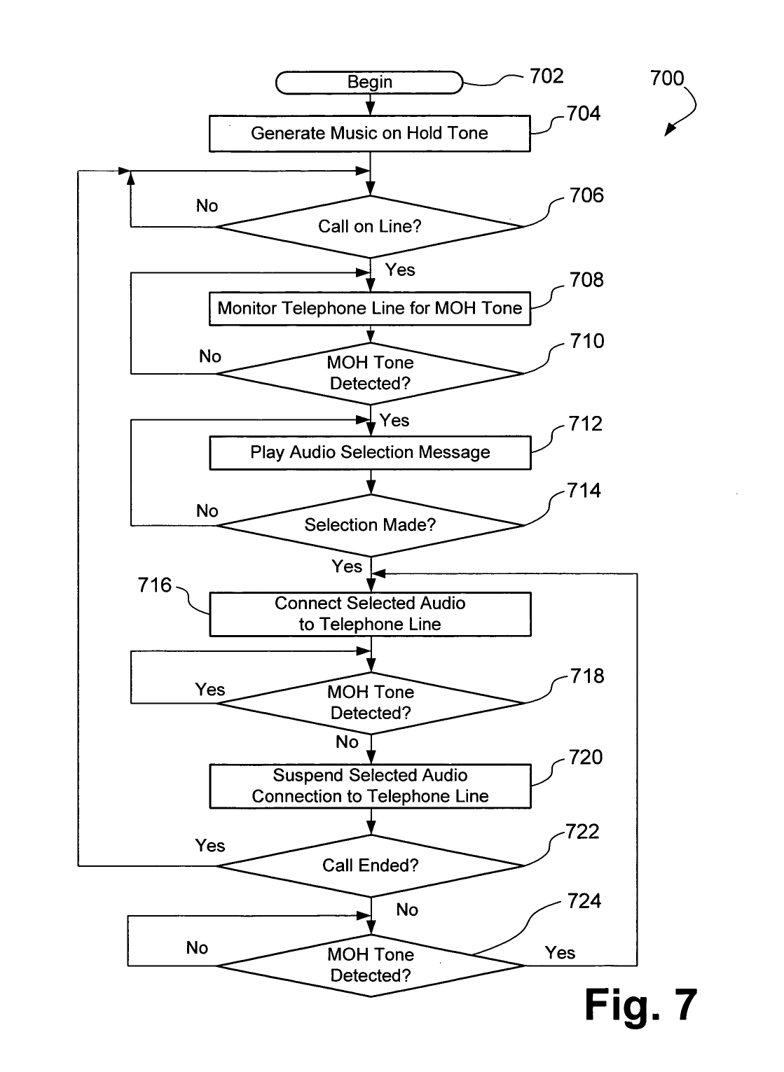

FIG. 7 is a flow diagram illustrating logical steps for detecting callers placed on hold in providing selected on-hold audio content to those callers. Flow diagram 700 begins at step 702. Operation may begin with powering up of audio controller 150 (FIG. 4), or with activation of a power mechanism. At step 704, music on-hold tone is generated and supplied to audio on-hold input 440 of telephone switching system 120. At decision step 706, it is determined if there is a call on the line. If not, flow diagram 700 loops to decision step 706 until a call is detected on the line. On the other hand, once a call is detected on the line at decision step 706, at step 708 the telephone line is then monitored for presence of the music on-hold tone. It will be appreciated that the telephone line could be monitored for the music on-hold tone at all times, although if there is no call on the line of provision of selected audio content will not commence.

At decision step 710, it is determined if the music on-hold tone has been detected on the telephone line if not, flow diagram 700 loops to step 708 to continue monitoring for the music on-hold tone. On the other hand, when the music on-hold tone is determined to be detected at decision step 710, at step 712, the audio selection message is played for the caller. The audio selection message, as previously described, lists for the user what audio content choices are available, and what key the user should press for word the user should say to select each.

At decision step 714, it is determined if the caller has made a selection of on-hold audio content. If not, in one embodiment of the present invention, flow diagram 700 loops to step 712 to commence replaying the audio selection message. On the other hand, at decision step 714 if it is determined in the selection has been made, flow diagram 700 proceeds to step 716 to connect the selected audio to the telephone line used by the caller.

Once the caller has been connected to the selected audio content at step 716, at decision step 718, it is determined if the music on-hold tone is again detected. If the music on-hold tone is detected, flow diagram 700 loops to decision step 718 to continue to determine if the music on-hold tone is detected. Thus, as long as the caller is on hold, causing the telephone switching system to apply the music on-hold tone supplied by audio system 430 (FIGS. 4 and 6) to the audio on-hold input 440 of the telephone switching system, the selected audio continues to be supplied to the caller. On the other hand, at decision step 718 if it is determined at the music on-hold tone is no longer detected, at step 720, connection of the selected audio is suspended from the telephone line. The connection between the audio system in the telephone line may be opened, and/4, if the audio selected includes a pre-recorded message, playing of the message may be suspended.

At decision step 722, it is determined if the call has ended. It can be determined that the call has ended if, for example, line status Monitor 502 (FIG. 5) determines there is no longer a call on the line. If it is determined that the call has ended, flow diagram 700 loops to decision step 706 to await another call being placed on the line. On the other hand, if it is determined at decision step 722 that the call has not ended, at decision step 724 is determined if the music on-hold tone is once again detected. For example, although the caller may have reached his or her intended party, that party may have to put caller back on hold while performing some service for the caller. Accordingly, if at decision step 724 is determined that the music on-hold tone has been detected once more, flow diagram loops to step 716 to reconnect the selected audio of the telephone line. Accordingly, until it is determined at decision step 722 that the call has ended, the line is continually monitored to determine if the music on-hold tone has been detected so that the caller can be reconnected to the selected audio content.

While the preferred embodiment of the present invention has been illustrated and described, as noted above, many changes can be made without departing from the spirit and scope of the present invention. Accordingly, the scope of the present invention is not limited by the disclosure of the preferred embodiment.

1. A system for selectably changing media content provided to a caller on hold on a telephone line, the system comprising:
a telephone switching system interface configured to connect with a telephone switching system;
a telephone line interface operable to engage the telephone line outside the telephone switching system;
a control unit operably coupled with at least one of the telephone switching system and the telephone line, the control unit including:
an on-hold detector configured to determine when the callers is on hold;
an available media generator configured to convey to the telephone switching system interface a list of media selections available to the caller on hold; and
a media choice selector configured to receive a media choice made by the caller on hold and cause selected media content to be presented to the telephone line such that it can be heard by a caller.
